(19) United States
(12) Patent Application Publication
(10) Pub. No.: US 2015/0217469 A1
(43) Pub. Date: Aug. 6, 2015

(54) WALLBOARD CUTTING TOOL

(71) Applicants: CRAIG A. VOGELER, North Loop, NE (US); David M. Lech, Ord, NE (US); John W. Weiner, North Loop, NE (US)

(72) Inventors: CRAIG A. VOGELER, North Loop, NE (US); David M. Lech, Ord, NE (US); John W. Weiner, North Loop, NE (US)

(21) Appl. No.: 14/169,355

(22) Filed: Jan. 31, 2014

(51) Int. Cl. B26B 29/06

(52) U.S. Cl. CPC B26B 29/06

(57) ABSTRACT

A wallboard cutting tool is provided which may simultaneously score or cut opposite sides of a wallboard. The cutting tool includes a blade safety guard assembly which encloses the cutting blades of the tool when the tool is not being used. The tool of this invention also includes a leg guide assembly positioned at the lower end of the legs of the tool. The tool of this invention also includes a push handle and a hold-down handle.

### BACKGROUND OF THE INVENTION

1. Field of the Invention

This invention relates to a wallboard cutting tool and more particularly to a cutting tool which may be used to simultaneously score or cut opposite sides of the wallboard being cut.

2. Description of the Related Art

Wallboards or sheetrock are generally rectangular and usually are four feet wide and seven or eight feet long. In the past, when it was found necessary to cut some portion of one side edge or some portion of an end edge from the wallboard to make it fit, a straightedge was normally placed on one side of the wallboard with a cutting knife then being moved along one edge of the straightedge to score or cut through the paper at one side of the wallboard. Upon being scored, the carpenter or drywall installer would attempt to break that portion of the wallboard being cut away and then reached through the cut portion with a cutting knife and attempt to cut the paper at the back side of the wallboard. In some cases, the carpenter would turn the wallboard over and then cut through the paper on the opposite side of the wallboard along the crease therein formed by partially breaking the cut portion from the remainder of the wallboard. The prior art methods just described frequently resulted in irregular cut edges which then would have to be sanded to provide a smooth edge.

Applicant's wallboard cutting tool shown and described in U.S. Pat. No. 8,272,136 B2 represents a major improvement in the wallboard cutting art. The instant invention represents a further advance in the wallboard cutting art.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A wallboard cutting tool is described which includes a vertically disposed leg assembly having a first vertically disposed leg with an upper end, a lower end, a forward end, a rearward end, an outer side and an inner side. The outer side of the first leg has measurement indicia thereon. The leg assembly also includes a second vertically disposed leg with an upper end, a lower end, a forward end, a rearward end, an outer side and an inner side. A base plate is secured to the upper ends of the first and second legs to vertically space the first and second legs.

A first cutting blade is secured to the lower end of the first leg which extends horizontally inwardly therefrom. A second cutting blade is secured to the lower end of the second leg which extends horizontally inwardly therefrom in the same vertical plane as the first cutting blade. The inner ends of the first and second cutting tool blades are horizontally spaced apart.

A first leg guide is secured to the lower end of the first leg and extends horizontally forwardly therefrom. A second leg guide is secured to the lower end of the second leg and extends horizontally forwardly therefrom. The first and second leg guides are horizontally spaced apart.

A blade safety guard is provided which is selectively removably secured to the lower ends of the first and second legs which encloses the first and second cutting blades. The blade safety guard is tethered to the lower end of one of the first and second legs.

The tool of this invention also includes a body assembly which is selectively vertically slidably mounted on the first and second legs. Body assembly includes a horizontally disposed body having a forward end, a rearward end, an upper end, a lower end, a first side and a second side. An elongated wallboard receiving channel extends upwardly into the lower end of the body between the forward and rearward ends thereof. The wallboard receiving channel is adapted to receive the edge of a wallboard so that the first and second cutting blades will be in cutting engagement with the opposite sides of the wallboard. A push handle extends upwardly and forwardly from the upper rearward end of the body. A hold-down handle extends upwardly from the upper forward end of the body. The body is positioned between the first and second legs and is selectively held in adjustment positions by a toggle clamp assembly which is secured to the body and the first and second legs.

It is a principal object of the invention to provide an improved wallboard cutting tool.

A further object of the invention is to provide a wallboard cutting tool which includes a push handle and a hold-down handle.

A further object of the invention is to provide an improved wallboard cutting tool which includes a blade safety guard.

A further object of the invention is to provide an improved wallboard cutting tool which includes a pair of leg glides.

A further object of the invention is to provide an improved wallboard cutting tool which is economical of manufacture, durable in use and refined in appearance.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of the wallboard cutting tool of this invention being used to cut the opposite sides of a wallboard, with portions of the wallboard being cut away to more fully illustrate the invention;

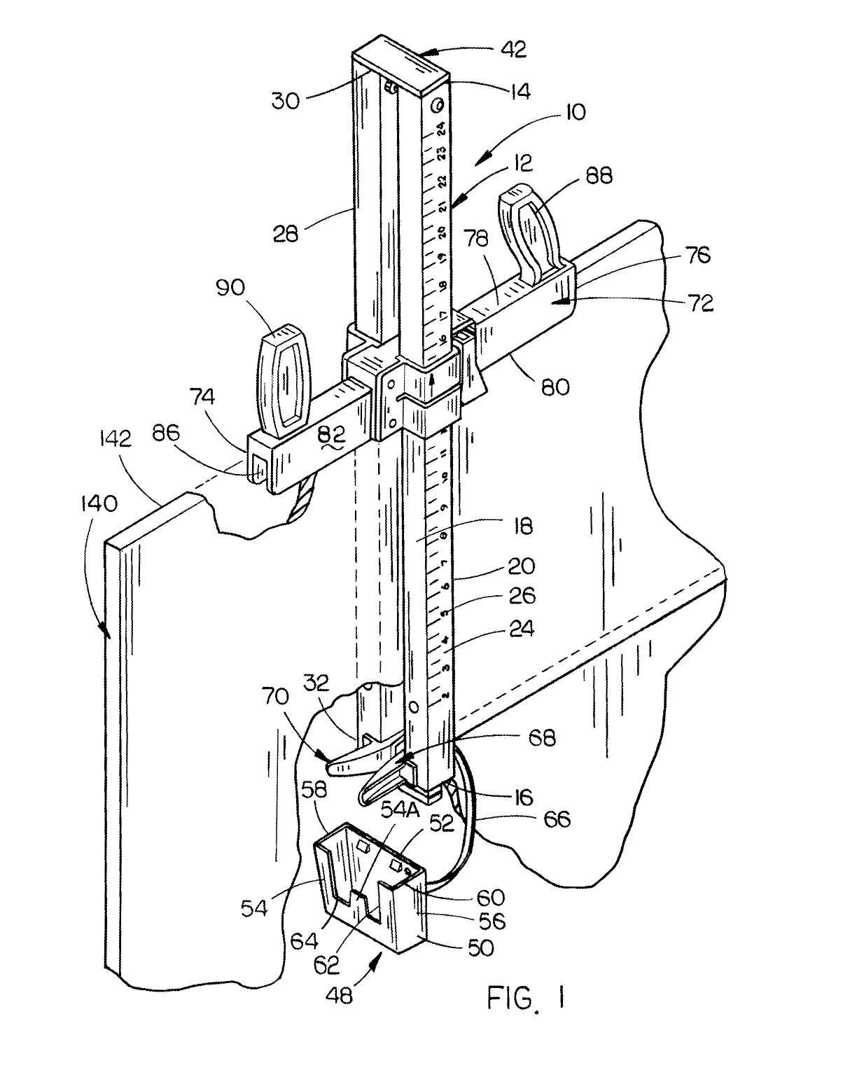

FIG. 2 is a side view of the wallboard cutting tool of this invention with the broken lines at the lower end of the tool illustrating the blade safety guard in its blade guard position;

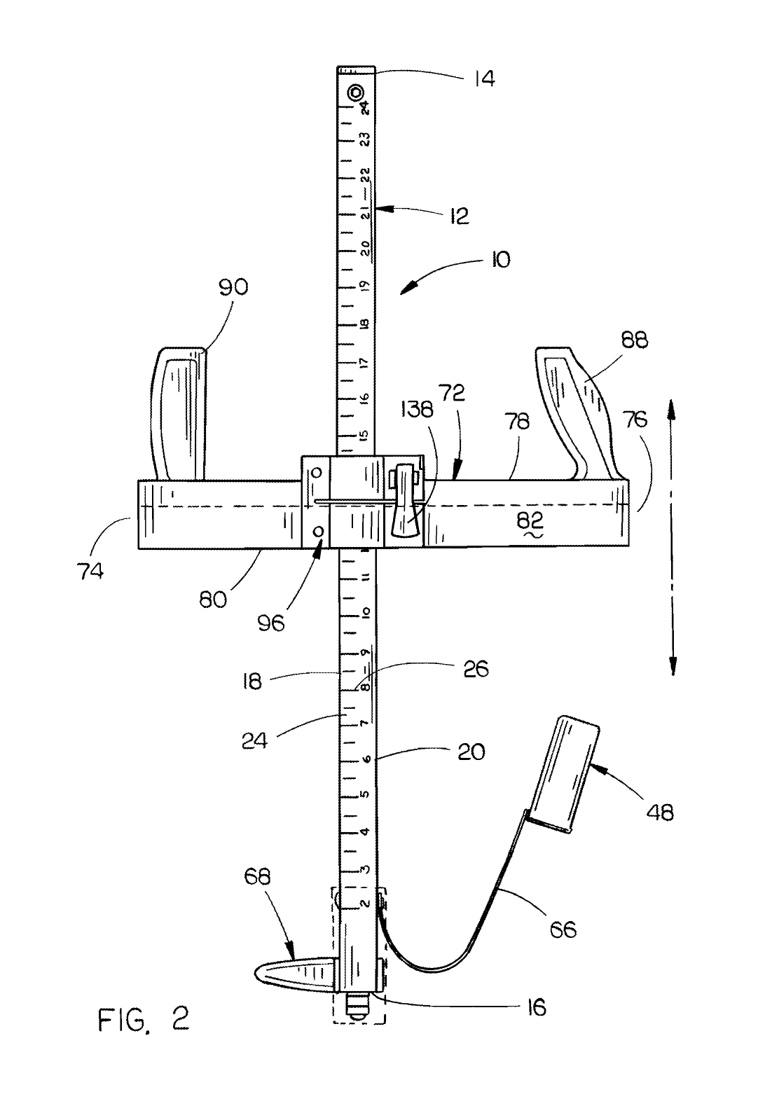

FIG. 3 is a partial exploded perspective view of the wallboard cutting tool of this invention;

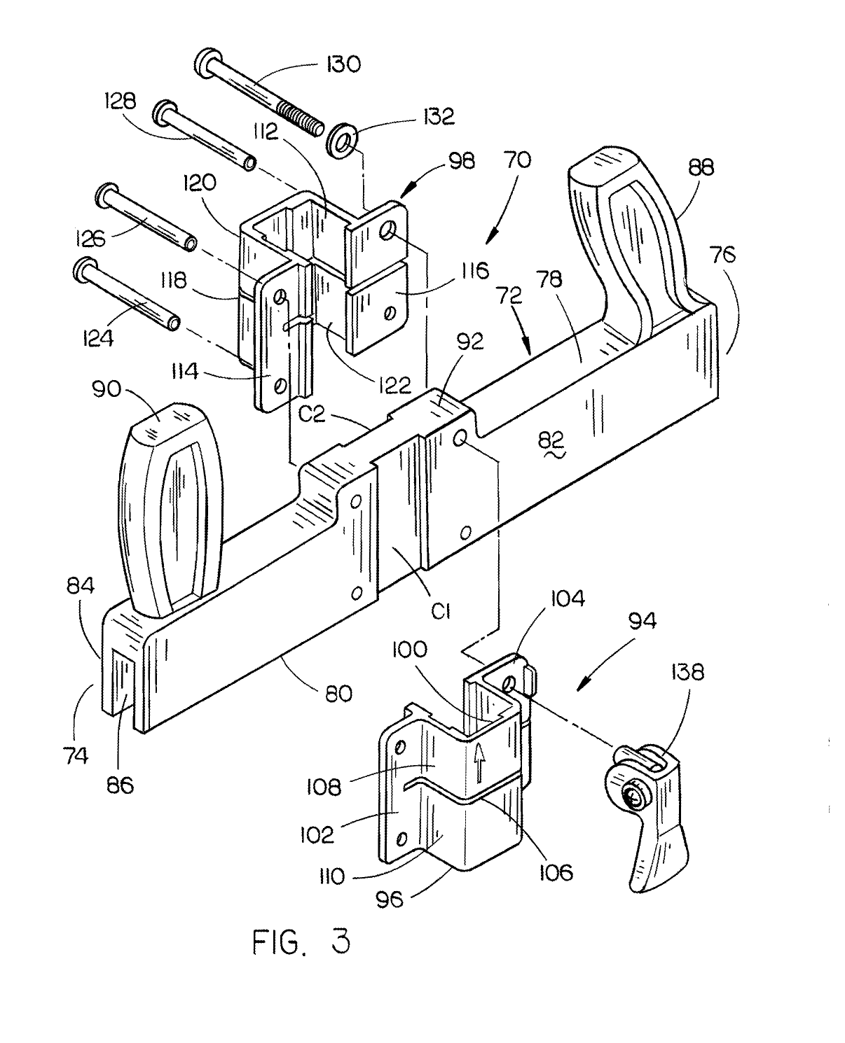

FIG. 4 is a partial exploded perspective view of the structure which interconnects the upper ends of the legs of the leg assembly;

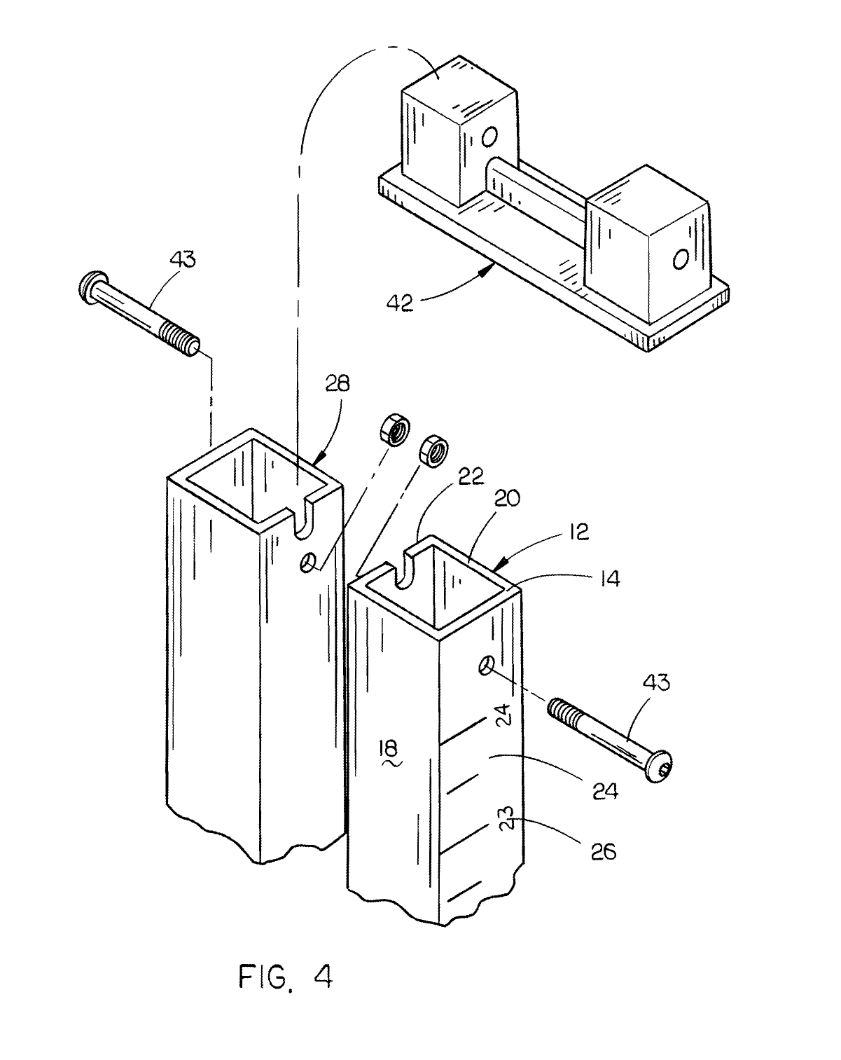

FIG. 5 is a partial exploded lower perspective view of the leg guide assembly and the blade holder assembly;

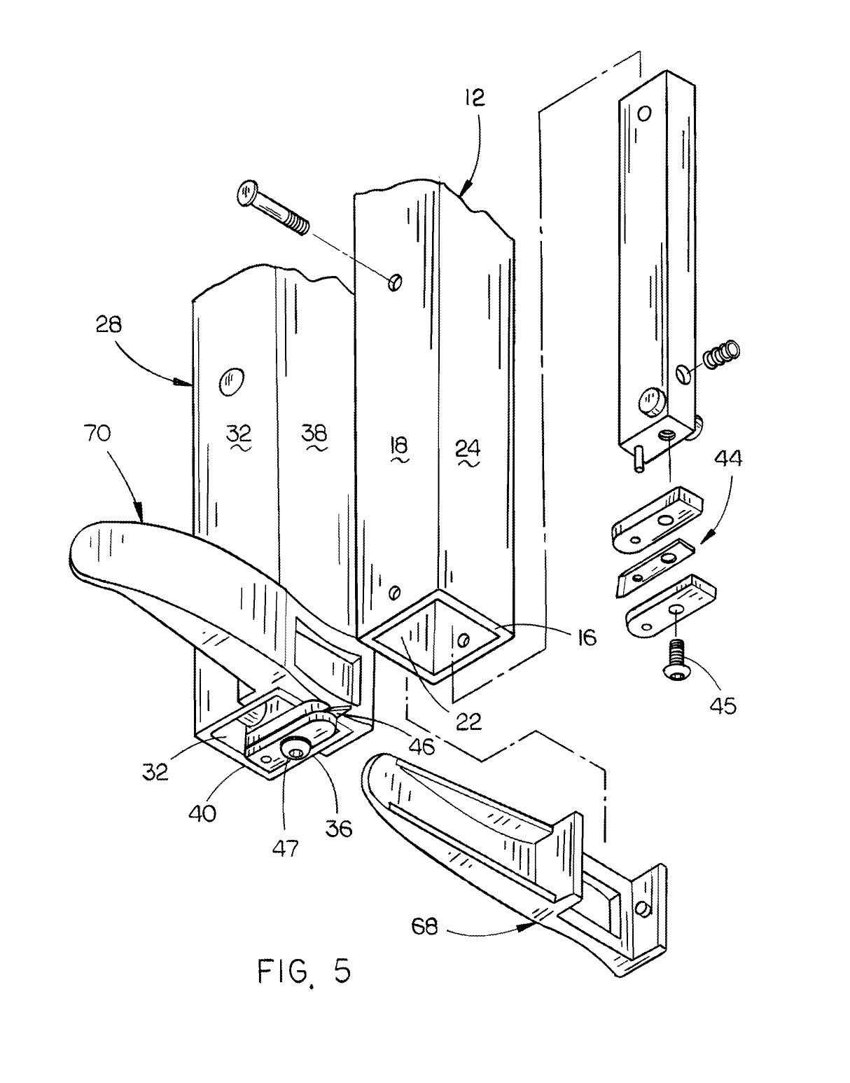

FIG. 6 is a partial sectional view illustrating the leg guide assembly and the blade holder assembly during the guiding and cutting of a wallboard; and

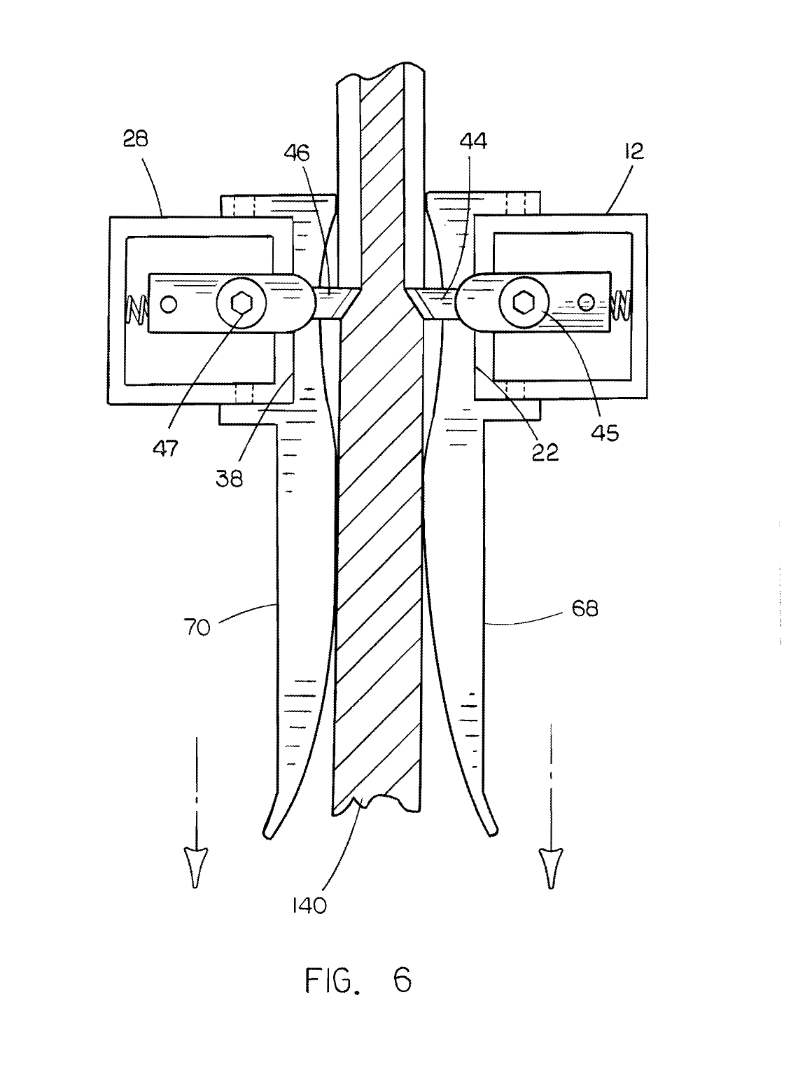

FIG. 7 is a sectional view which illustrates the clamping assembly of this invention.

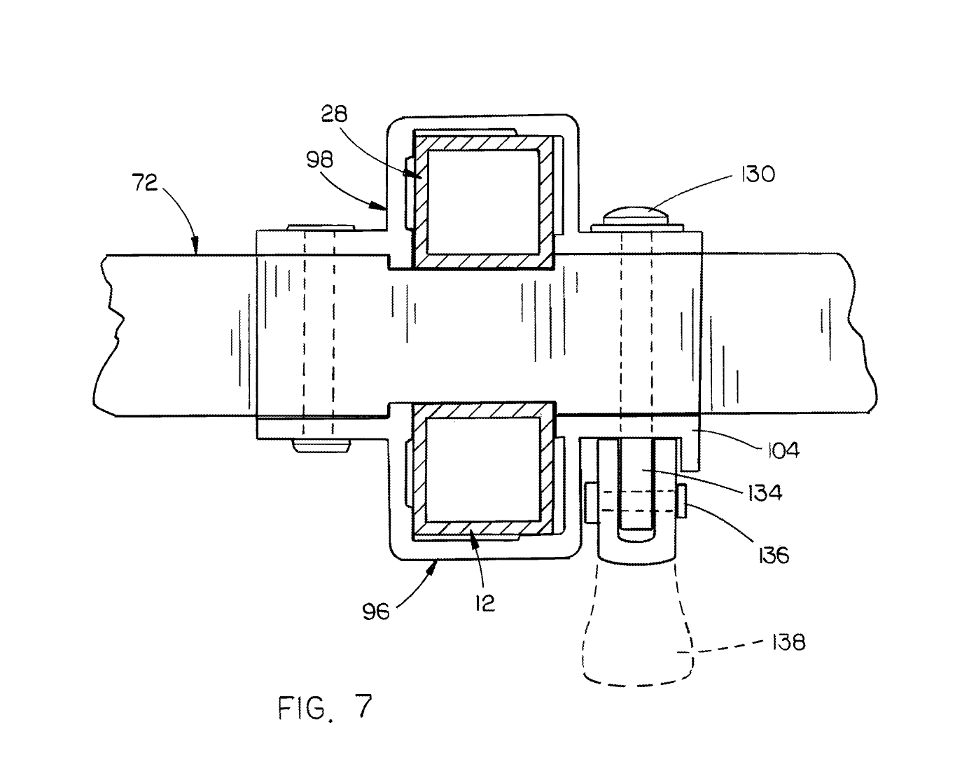

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The wallboard cutting tool of this invention is generally designated by the reference numeral 10. The tool 10 will be described as being in the wallboard cutting position for the purpose of clarity.

Tool 10 includes a first elongated leg 12 having an upper end 14, lower end 16, forward end 18, rearward end 20, inner side 22 and outer side 24. The outer side 24 of leg 12 has measurement indicia 26 thereon. Tool 10 also includes a second elongated leg 28 having an upper end 30, lower end 32, forward end 34, rearward end 36, inner side 38 and outer side 40. A base plug or plate 42 is secured to the upper ends 14 and 30 of legs 12 and 28 respectively by bolts 43. Plate 42 aids in maintaining legs 12 and 28 in a horizontally spaced-apart and parallel position.

A first cutting member or blade 44 is secured to the lower end of leg 12 by screw 45 and extends horizontally inwardly therefrom. A second cutting member or blade 46 is secured to the lower end of leg 28 by screw 47 and extends horizontally inwardly therefrom. As seen, the inner ends of blades 44 and 46 are horizontally spaced-apart and dwell in the same vertical plane.

The numeral 48 refers to a generally cup-shaped blade safety guard. Guard 48 includes a horizontally disposed bottom wall 50, side walls 52 and 54 which extend upwardly and outwardly from bottom wall 50, and end walls 56 and 58 which extend upwardly and outwardly from bottom wall 50. Preferably, the upper ends of walls 52, 54, 56 and 58 have a lip 60 therein which extends outwardly therefrom. Side wall 54 has a pair of slots 62 and 64 formed therein which extend downwardly from the upper end of side wall 52. Slots 62 and 64 are separated by a wall portion 54A. Guard 48 is tethered to the lower end of leg 12 by a flexible tether 66. An elongated leg guide 68 has its rearward end snap-fitted onto the lower end of leg 12 and extends from the inner side 22 thereof in a forwardly and outwardly manner therefrom. An elongated leg guide 70 has its rearward end snap-fitted onto the lower end of leg 28 and extends from the inner side 38 thereof in a forwardly and outwardly manner therefrom.

The numeral 72 refers to a horizontally disposed wallboard engaging member or body which is vertically movably positioned between legs 12 and 28 as seen in the drawings. Body 72 has a forward end 74, rearward end 76, upper end 78, lower end 80, a first or outer side 82, and a second or inner side 84. An elongated and horizontally extending wallboard receiving channel 86 extends upwardly onto lower end 80 of body 12 between the forward end 74 and rearward end 76 thereof.

A push handle 88 extends upwardly and forwardly from the upper end 76 of body 72 adjacent the rearward end 76 thereof. A hold-down handle 90 extends upwardly from the upper end 76 of body 72 adjacent the forward end 74 thereof.

As seen in the drawings, body 72 has a centrally disposed block portion 92 which extends upwardly therefrom. Body 72 and block portion 92 have vertically disposed channels C1 and C2 formed therein. The numeral 94 refers to a clamping mechanism for clamping the body 72 in various longitudinal positions with respect to legs 12 and 26. Clamping mechanism 94 includes spaced-apart clamps 96 and 98. Clamp 96 includes a vertically disposed channel 100, which slidably embraces leg 12, and wing portions 102 and 104. A horizontally disposed slot 106 is formed in clamp 96 to define an upper clamp portion 108 and a lower clamp portion 110.

Clamp 98 includes a vertically disposed channel 112, which slidably embraces leg 28, and wing portions 114 and 116. A horizontally disposed slot 118 is formed in clamp 98 to define an upper clamp portion 120 and a lower clamp portion 122.

Pin or bolt 124 extends through an opening in the lower forward end of wing portion 114 of clamp 98, through body 72 and through an opening in the lower forward end of wing portion 102 of clamp 96. Pin or bolt 126 extends through an opening in the upper forward end of wing portion 114, through block portion 92 and through an opening in the upper forward end of wing 102 of clamp 96. Pin or bolt 128 extends through an opening in the lower rearward end of wing 116, through body 72, and through an opening in the lower rearward end of wing 104 of clamp 96. Pin or bolt 130 extends through an opening in the upper rearward end of wing 116, through block portion 92, and through an opening in the upper rearward end of wing 104 of clamp 96. A washer 132 embraces pin 130 at the outer side of wing 104 of clamp 96. Sleeve 134 embraces pin 130 outwardly of washer 132. The outer end of sleeve 134 is pinned to pin 130 by pin 136. Toggle clamp lever 138 is pivotally secured to pin 136. When the clamp lever 138 is in the “off” position, the legs 12 and 26 may be slidably moved with respect to body 72 or vice versa. When the clamp lever 138 is in the “on” position, the upper clamp portion 120 of wing 104 of clamp 96 and the upper clamp portion 108 of wing 102 will be drawn into frictional engagement with body 72 to lock the body 72 in the desired position with respect to the legs 12 and 28. The tool 10 is designed to cut opposite sides of a wallboard 140 having an edge 142.

When it is desired to cut a portion of the wall board 140, the wallboard is placed on its edge against a cleat or stop. The cutting depth of the tool is adjusted by lifting the toggle clamp lever 138 to enable the legs 12 and 28 to be longitudinally adjusted with respect to the body 72. The top edge of the clamp 94 indicates the cutting depth on the measurement indicia 26. Cutting depth may be adjusted from 2 inches to 24 inches. The toggle clamp lever 138 is then pushed downwardly to lock the legs 12 and 28 into position. The body 72 is placed at one end of the edge to be cut with the guides 68 and 70 properly positioning the legs 12 and 28 on opposites of the wallboard 140. The edge 142 is received by the slot 86. The rear push handle 88 is then pushed with force to begin cutting while holding the front handle 90 down. When the sides of the wallboard 140 have been scored or cut by the cutting blades 44 and 46, the tool is removed from the wallboard. That portion of the wallboard 140 which has been scored will then be broken from the wallboard. As soon as the tool has been removed from the wallboard, the blade safety guard assembly 48 is then positioned on the lower ends of the legs 12 and 28 to cover the cutting blades to prevent a person from inadvertently coming into contact with the blades.

It can therefore be seen that a novel wallboard cutting tool has been provided which is easily adjusted and easy to use in an accurate manner.

Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

We claim:

1. A wallboard cutting tool, comprising:
a first elongated and vertically disposed leg having an upper end, a lower end, a forward side, a rearward side, an inner side and an outer side;
a second elongated and vertically disposed leg having an upper end, a lower end, a forward side, a rearward side, an inner side and an outer side;
said first and second legs being horizontally spaced-apart and being parallel to one another;
at least one of said legs having measurement indicia thereon;
a support secured to and extending between said upper ends of said first and second legs;
a first cutting member at said lower end of said first leg which extends inwardly therefrom;
a second cutting member at said lower end of said second leg which extends inwardly therefrom;
said second cutting member being in the same vertical plane as said first cutting member;
said first and second cutting members having inner ends which are horizontally spaced-apart;
a horizontally disposed and elongated wallboard engagement body having a first end, a second end, a forward end, a rearward end, an upper end, a lower end, a first side and a second side;
said wallboard engagement body having an elongated wallboard receiving slot extending upwardly into said lower end therein;
said wallboard engagement body being received between said first and second legs in a transverse manner;
said wallboard engagement body being selectively vertically movably mounted on said first and second legs;
a clamp mechanism operatively connected to said wallboard engagement body and said first and second legs which is configured to selectively vertically adjustably clamp said body engagement body to said first and second legs;
a push handle secured to said wall board engagement body which extends upwardly from said wallboard engagement body adjacent said upper rearward end thereof; and
a hold-down handle secured to said wallboard engagement body which extends upwardly from said wallboard engagement body adjacent said upper forward end thereof.

2. The wallboard cutting tool of claim 1 wherein said push handle extends upwardly and forwardly from said wallboard engagement member.

3. The wallboard cutting tool of claim 1 wherein a first elongated leg guide is secured to said lower end of said first leg which extends forwardly therefrom and wherein a second elongated leg guide is secured to said lower end of said second leg which extends forwardly therefrom, said first and second leg guides being horizontally spaced-apart.

4. The wallboard cutting tool of claim 3 wherein said first leg guide extends forwardly and outwardly from said lower end of said first leg and wherein said second leg guide extends forwardly and outwardly from said lower end of said second leg.

5. The wallboard cutting tool of claim 1 wherein a blade safety guard is selectively removably secured to said lower ends of said first and second legs which is configured to selectively cover said first and second cutting members.

6. The wallboard cutting tool of claim 5 wherein said blade safety guard is tethered to one of said first and second legs.

7. A wallboard cutting tool, comprising:
a first elongated and vertically disposed leg having an upper end, a lower end, a forward side, a rearward side, an inner side and an outer side;
a second elongated and vertically disposed leg having an upper end, a lower end, a forward side, a rearward side, an inner side and an outer side;
said first and second legs being horizontally spaced-apart and being parallel to one another;
at least one of said legs having measurement indicia thereon;
a support secured to and extending between said upper ends of said first and second legs;
a first cutting member at said lower end of said first leg which extends inwardly therefrom;
a second cutting member at said lower end of said second leg which extends inwardly therefrom;
said second cutting member being in the same vertical plane as said first cutting member;
said first and second cutting members having inner ends which are horizontally spaced-apart;
a horizontally disposed and elongated wallboard engagement body having a first end, a second end, a forward end, a rearward end, an upper end, a lower end, a first side and a second side;
said wallboard engagement body member having an elongated wallboard receiving slot extending upwardly into said lower end thereof;
said wallboard engagement body being received between said first and second legs in a transverse manner;
said wallboard engagement body being selectively vertically movably mounted on said first and second legs;
a clamp mechanism operatively connected to said wallboard engagement body and said first and second legs which is configured to selectively vertically adjustably clamp said body engagement body to said first and second legs;
a first elongated leg guide secured to said lower end of said first leg which extends forwardly therefrom; and
a second elongated leg guide secured to said lower end of said second leg which extends forwardly therefrom.

8. The wallboard cutting tool of claim 7 wherein said first leg guide extends forwardly and outwardly from said lower end of said first leg and wherein said second leg guide extends forwardly and outwardly from said lower end of said second leg.

9. A wallboard cutting tool, comprising:
a first elongated and vertically disposed leg having an upper end, a lower end, a forward side, a rearward side, an inner side and an outer side;
a second elongated and vertically disposed leg having an upper end, a lower end, a forward side, a rearward side, an inner side and an outer side;
said first and second legs being horizontally spaced-apart and being parallel to one another;
at least one of said legs having measurement indicia thereon;
a support secured to and extending between said upper ends of said first and second legs;
a first cutting member at said lower end of said first leg which extends inwardly therefrom;
a second cutting member at said lower end of said second leg which extends inwardly therefrom;
said second cutting member being in the same vertical plane as said first cutting member;
said first and second cutting members having inner ends which are horizontally spaced-apart;
a horizontally disposed and elongated wallboard engagement body having a first end, a second end, a forward end, a rearward end, an upper end, a lower end, a first side and a second side;
said wallboard engagement body having an elongated slot formed therein which extends upwardly into said lower end thereof;
said wallboard engagement body being received between said first and second legs in a transverse manner;
said wallboard engagement body being selectively vertically movably mounted on said first and second legs;
a clamp mechanism operatively connected to said wallboard engagement body and said first and second legs which is configured to selectively vertically adjustably clamp said body engagement body to said first and second legs;
a blade safety guard selectively removably secured to said lower ends of said first and second legs which is configured to selectively cover said first and second cutting members.

10. The wallboard cutting tool of claim 9 wherein said blade safety guard is tethered to one of said first and second legs.
